(19) United States
(12) Patent Application Publication
(10) Pub. No.: US 2015/0161486 A1
(43) Pub. Date: Jun. 11, 2015

(54) DETERMINING AN OBJECT LOCATION RELATIVE TO A DIGITAL DOCUMENT

(71) Applicants: Robin Cole, Seattle, WA (US); Phillipp Schmid, Seattle, WA (US); Ben McAllister, Seattle, WA (US); R. Matthews Wesson, Seattle, WA (US)

(72) Inventors: Robin Cole, Seattle, WA (US); Phillipp Schmid, Seattle, WA (US); Ben McAllister, Seattle, WA (US); R. Matthews Wesson, Seattle, WA (US)

(21) Appl. No.: 14/622,476

(22) Filed: Feb. 13, 2015

Related U.S. Application Data
(63) Continuation of application No. 12/750,444, filed on Mar. 30, 2010, now abandoned.

(51) Int. Cl. G06K 15/02; G06F 17/21; G06F 3/0354; G06F 17/24; G06K 9/00; G06F 3/0488

(52) U.S. Cl. CPC G06K 15/181; G06K 9/00416; G06F 3/04883; G06F 3/03545; G06F 17/242; G06F 17/212; G06K 9/00449; G06K 15/1893

(57) ABSTRACT

Systems and methods for determining an object location relative to a digital document are disclosed herein. A marking is applied to at least one cell in at least one row and to at least one cell in at least one column of a digital document. The markings define an axis system for the digital document. Each object has a stored digital address within the digital document. When the digital document is converted into a fixed file format, a location of the object can be determined that will match the location of the object on the printed page. By comparing the digital address of the object to the axis system defined by the markings, after the document has been converted to a fixed document format, the location of the object is defined spatially.

### PRIORITY CLAIM

This application claims priority to U.S. patent application Ser. No. 12/750,444 filed on Mar. 30, 2010, the subject matter of which is incorporated herein by reference in its entirety.

### BACKGROUND OF THE INVENTION

Conventional digital paper systems, which include a digital writing surface and a digital pen device, have become very popular. The digital pen device determines its location in real time on the digital writing surface, which may include a visible or non-visible digital pattern. The writing surface may take the form of a digital tablet or digital paper, for example digital paper made by the Anoto Group AB and having an ANOTO® pattern. Various types of conventional digital pen devices include, but are not limited to, the MAXELL® digital pen, the NOKIA® digital pen, the LEAPFROG FLYFUSION® digital pen, LIVSCRIBE® Pulsepen, the ANOTO® digital pen, and the LOGITECH® digital pen. Besides knowledge of placement location, some digital paper systems also maintain records of information like pressure or time as well as various “state” values such as color or width.

The digital pattern enables the digital pen to interact with printed content, text, lines, images, etc. which may take the form of spreadsheets, maps, AutoCAD layouts, etc. The printed content is overlaid on top of, or otherwise applied to the digital pattern, which allows the digital pen to “see through” the printed content and capture its exact position from the digital pattern.

### BRIEF DESCRIPTION OF THE DRAWINGS

Preferred and alternative examples of the present invention are described in detail below with reference to the following drawings:

FIG. 1 is a block diagram showing a conventional prior-art computer, various computer peripherals, and various communication means for the computer according to an embodiment of the invention;

FIG. 2 is a schematic view of a system for determining an object location in a converted document according to an embodiment of the invention;

FIG. 3 is a flowchart showing a method of determining an object location relative to a converted digital document according to an embodiment of the invention;

FIG. 4A shows a screen view of a digital document having a variety of objects according to an embodiment of the invention;

FIG. 4B shows a screen view of a digital document have the objects of FIG. 4A corresponding to a coded axis system according to an embodiment of the invention;

FIG. 5 shows a screen view of a table for storing a relationship between an object address and a coded axis system according to an embodiment of the invention; and

FIG. 6 shows the digital document of FIG. 4B converted according to an embodiment of the invention.

### DETAILED DESCRIPTION

In the following description, certain specific details are set forth in order to provide a thorough understanding of various embodiments of the invention. However, one skilled in the art will understand that the invention may be practiced without these details or with various combinations of these details. In other instances, well-known systems and methods associated with, but not necessarily limited to, locating objects in digital documents, digital paper systems, digital pens and methods for operating the same may not be shown or described in detail to avoid unnecessarily obscuring descriptions of the embodiments of the invention. For purposes of the description herein, the phrase “digital ink” refers generally to the handmade strokes made and optionally recorded by a digital pen.

Generally, when using digital ink and digital paper, handwritten strokes made by a digital pen are converted automatically into text and stored digitally. In some examples, the converted handwritten strokes are stored within a digital document at a precise location where they were written on the digital paper. However, some digital documents cannot be used to precisely define object locations on printed pages, where an object may be a text box, a cell, a list, etc. In fact, traditional file formats do not guarantee placement of precise rectangles from a digital document to a printed page. For example a cell within a spreadsheet may appear to a form designer to be on the first page of the spreadsheet and located generally in the bottom right corner of that page. However, whether because of formatting, print options, conversion instructions, scaling, once printed the cell is actually located in the top right corner of a second page, instead of the anticipated location. If the digital ink conversion program searches for the cell in the bottom right corner of the first printed page or a digitally represented printed page, then the cell will not be found and thus the conversion may likely fail.

The present invention is generally directed to systems and methods for determining an object location relative to a converted digital document. In one embodiment, the coordinates of an object (e.g., an object address) in a spreadsheet are converted into an Extensible Markup Language (“XML”) paper specification (“XPS”) file. The coordinates are generally determined before conversion. For example, a spreadsheet program assigns an object address based on its column and row location. In addition, markings are applied to the XPS file to define an axis system within the spreadsheet and may include, but are not limited to, sequential colors, patterns, grey scale shades, fills, or shapes.

After conversion, each object address may be associated with the markings on the spreadsheet. Once the document is converted to an XPS file, the markings are readable by a program converted to locate, for example 32 bit color, which matches the markings to the object digital address. Once the location of the markings are determined by matching the markings to the object digital address, a spatial location is assigned to the object. In one embodiment, the location of the object in the XPS file corresponds to the location of the object when printed on digital paper or displayed in a fixed document file format on a display device. In alternate embodiments, any page description language or fixed-layout document format can be used such as postscript and portable document format when converting a digital document.

Another embodiment of the present invention relates to positioning objects in the digital document, and subsequently determining their locations on a printed page. The location of the positioned object is determined by a plurality of colors sequentially aligned on the digital document to delineate an axis system. Using the axis system and after converting the digital document into a fixed file format such as XPS, the objects are located spatially within the XPS file by matching the object to the axis system.

Another embodiment of the present invention relates to using a spreadsheet program to create digital paper forms with input cells configured to receive handwriting from a digital pen. To correctly associate questions from answers, the location of both needs to be accurately defined on the digital paper form. This is especially important when the digital forms are dense, meaning there is little space between respective cells. In order to link the locations of question and answer in the digital paper form to question and answer on digital paper color is applied to at least one cell in at least one row and to at least one cell in at least one column of the digital document. In this manner, the colors define an axis system for the digital paper form. Each cell has a stored digital address within the digital document. Therefore, when the digital document is converted into a fixed file format such as an XPS file, a location of the cell can be determined that will match the location of the object on the printed page. By comparing the digital address of the object to the axis system defined by the colors, after the document has been converted to the XPS file, the location of the object is defined spatially.

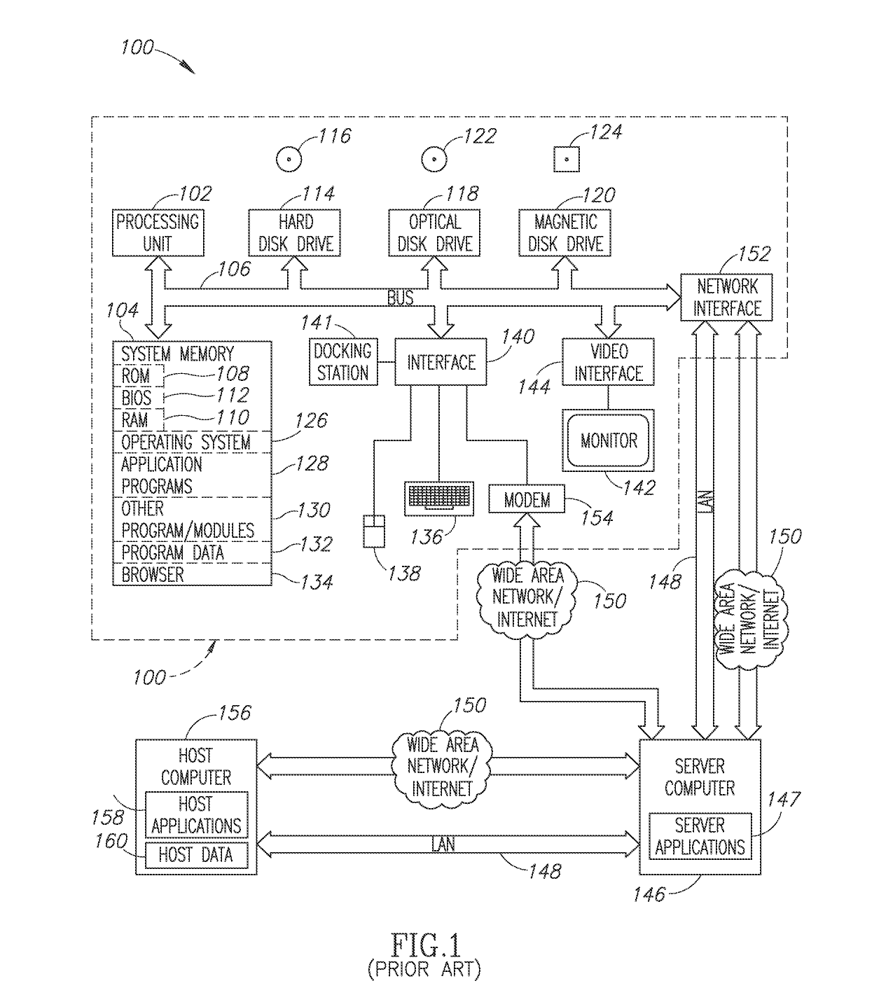

FIG. 1 is a block diagram showing a conventional prior-art computer, various computer peripherals, and various communication means for the computer according to an embodiment of the invention. For purposes of brevity and clarity, embodiments of the invention may be described in the general context of computer-executable instructions, such as program application modules, objects, applications, models, or macros being executed by a computer, which may include but is not limited to personal computer systems, hand-held devices, multiprocessor systems, microprocessor-based or programmable consumer electronics, network PCs, mini computers, mainframe computers, and other equivalent computing and processing sub-systems and systems. Aspects of the invention may be practiced in distributed computing environments where tasks or modules are performed by remote processing devices linked through a communications network. Various program modules, data stores, repositories, models, federators, objects, and their equivalents may be located in both local and remote memory storage devices.

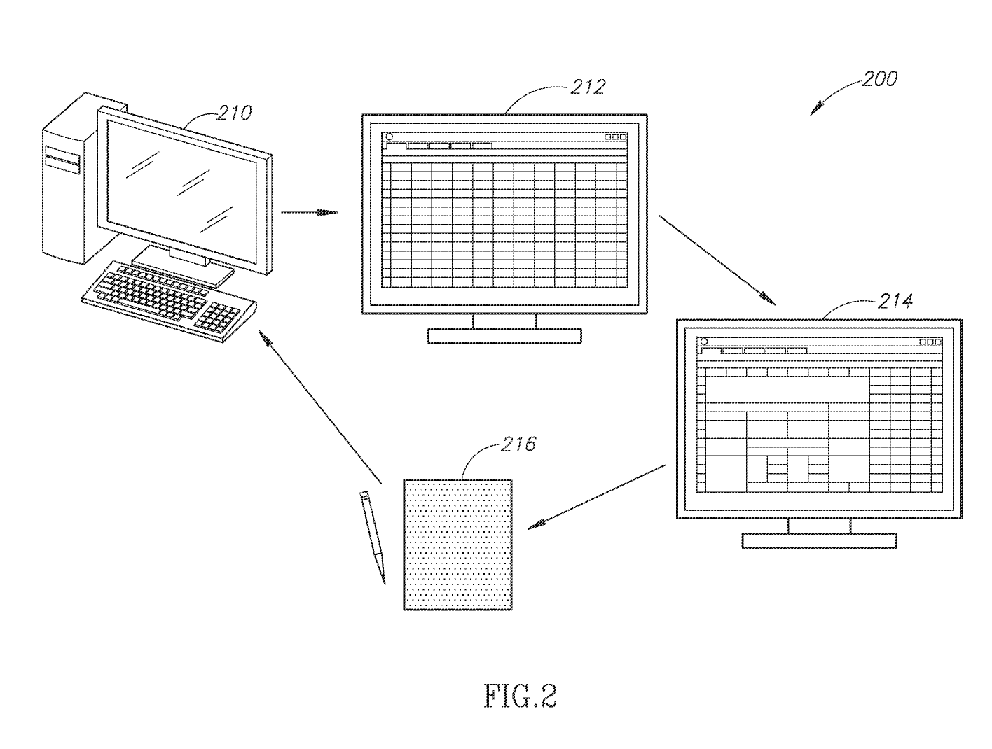

By way of example, a conventional personal computer , referred to herein as a computer 100, includes a processing unit 102, a system memory 104, and a system bus 106 that couples various system components including the system memory to the processing unit. The computer 100 will at times be referred to in the singular herein, but this is not intended to limit the application of the invention to a single computer since, in typical embodiments, there will be more than one computer or other device involved. The processing unit 102 may be any logic processing unit, such as one or more central processing units (CPUs), digital signal processors (DSPs), application-specific integrated circuits (ASICs), etc. Unless described otherwise, the construction and operation of the various blocks shown in FIG. 2 are of conventional design. As a result, such blocks need not be described in further detail herein, as they will be understood by those skilled in the relevant art.

The system bus 106 can employ any known bus structures or architectures, including a memory bus with memory controller, a peripheral bus, and a local bus. The system memory 104 includes read-only memory (“ROM”) 108 and random access memory (“RAM”) 110. A basic input/output system (“BIOS”) 112, which can form part of the ROM 108, contains basic routines that help transfer information between elements within the computer 100, such as during start-up.

The computer 100 also includes a hard disk drive 114 for reading from and writing to a hard disk 116, and an optical disk drive 118 and a magnetic disk drive 120 for reading from and writing to removable optical disks 122 and magnetic disks 124, respectively. The optical disk 122 can be a CD-ROM, while the magnetic disk 124 can be a magnetic floppy disk or diskette. The hard disk drive 114, optical disk drive 118, and magnetic disk drive 120 communicate with the processing unit 102 via the bus 106. The hard disk drive 114, optical disk drive 118, and magnetic disk drive 120 may include interfaces or controllers (not shown) coupled between such drives and the bus 106, as is known by those skilled in the relevant art. The drives 114, 118, 120, and their associated computer-readable media, provide nonvolatile storage of computer readable instructions, data structures, program modules, and other data for the computer 100. Although the depicted computer 100 employs hard disk 116, optical disk 122, and magnetic disk 124, those skilled in the relevant art will appreciate that other types of computer-readable media that can store data accessible by a computer may be employed, such as magnetic cassettes, flash memory cards, digital video disks (“DVD”), Bernoulli cartridges, RAMs, ROMs, smart cards, etc.

Program modules can be stored in the system memory 104, such as an operating system 126, one or more application programs 128, other programs or modules 130 and program data 132. The system memory 104 also includes a browser 134 for permitting the computer 100 to access and exchange data with sources such as web sites of the Internet, corporate intranets, or other networks as described below, as well as other server applications on server computers such as those further discussed below. The browser 134 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. Although the depicted embodiment shows the computer 100 as a personal computer, in other embodiments, the computer is some other computer-related device such as a personal data assistant (PDA), a cell phone, or other mobile device.

The operating system 126 may be stored in the system memory 104, as shown, while application programs 128, other programs/modules 130, program data 132, and browser 134 can be stored on the hard disk 116 of the hard disk drive 114, the optical disk 122 of the optical disk drive 118, and/or the magnetic disk 124 of the magnetic disk drive 120. A user can enter commands and information into the computer 100 through input devices such as a keyboard 136 and a pointing device such as a mouse 138. Other input devices can include a microphone, joystick, game pad, scanner, etc. These and other input devices are connected to the processing unit 102 through an interface 140 such as a serial port interface that couples to the bus 106, although other interfaces such as a parallel port, a game port, a wireless interface, or a universal serial bus (“USB”) can be used. A monitor 142 or other display device is coupled to the bus 106 via a video interface 144, such as a video adapter. The computer 100 can include other output devices, such as speakers, printers, etc.

The computer 100 can operate in a networked environment using logical connections to one or more remote computers, such as a server computer 146. The server computer 146 can be another personal computer, a server, another type of computer, or a collection of more than one computer communicatively linked together and typically includes many or all the elements described above for the computer 100. The server computer 146 is logically connected to one or more of the computers 100 under any known method of permitting computers to communicate, such as through a local area network (“LAN”) 148, or a wide area network (“WAN”) or the Internet 150. Such networking environments are well known in wired and wireless enterprise-wide computer networks, intranets, extranets, and the Internet. Other embodiments include other types of communication networks, including telecommunications networks, cellular networks, paging networks, and other mobile networks. The server computer 146 may be configured to run server applications 147.

When used in a LAN networking environment, the computer 100 is connected to the LAN 148 through an adapter or network interface 152 (communicatively linked to the bus 106). When used in a WAN networking environment, the computer 100 often includes a modem 154 or other device, such as the network interface 152, for establishing communications over the WAN/Internet 150. The modem 154 may be communicatively linked between the interface 140 and the WAN/Internet 150. In a networked environment, program modules, application programs, or data, or portions thereof, can be stored in the server computer 146. In the depicted embodiment, the computer 100 is communicatively linked to the server computer 146 through the LAN 148 or the WAN/Internet 150 with TCP/IP middle layer network protocols; however, other similar network protocol layers are used in other embodiments. Those skilled in the relevant art will readily recognize that the network connections are only some examples of establishing communication links between computers, and other links may be used, including wireless links.

The server computer 146 is further communicatively linked to a legacy host data system 156 typically through the LAN 148 or the WAN/Internet 150 or other networking configuration such as a direct asynchronous connection (not shown). Other embodiments may support the server computer 146 and the legacy host data system 156 on one computer system by operating all server applications and legacy host data system on the one computer system. The legacy host data system 156 may take the form of a mainframe computer. The legacy host data system 156 is configured to run host applications 158, such as in system memory, and store host data 160 such as business related data.

FIG. 2 is a schematic view of a system 200 for determining an object location in a converted document according to an embodiment of the invention. A digital document 212 contains at least one object and includes an axis system defined by markings at a set interval along the document. Objects include, but are not limited to input areas such as a text box, a cell, a list or other defined area configured to accept input from a user. The axis interval may be based on cell size, font size, page spacing, or custom setting by a user, but is preferably set based on cell size. In some embodiments, a cell size is the size of the smallest cell defined by a row and/or column. Each object has an address corresponding to its location within the digital document relative to the axis system. Each object address and location within the digital document is stored within a table.

The digital document is converted into a fixed-document format document 214, such as an XPS document. The XPS document is parsable and searchable. The XPS document contains the same defined axes, markings and objects as the digital document, but instead the objects are advantageously represented in the spatial location where they will be printed. To determine the spatial location of each object, the XPS document is parsed to determine the locations of each of the markings on the page. Once the locations of the markings are known, the table of object addresses and markings can advantageously be used to determine the spatial location of each object. This spatial location of each object is stored for future use during digital ink conversion as explained above.

Optionally, the XPS document is optionally printed on digital paper. In an embodiment, a digital pen is used to write on the digital paper within the defined objects. The handwriting, as stored digital ink, is uploaded onto the computer 210 for text conversion. Once the text is converted, the text is placed within the object of the digital document 212 based on its written location (object location) on the digital paper.

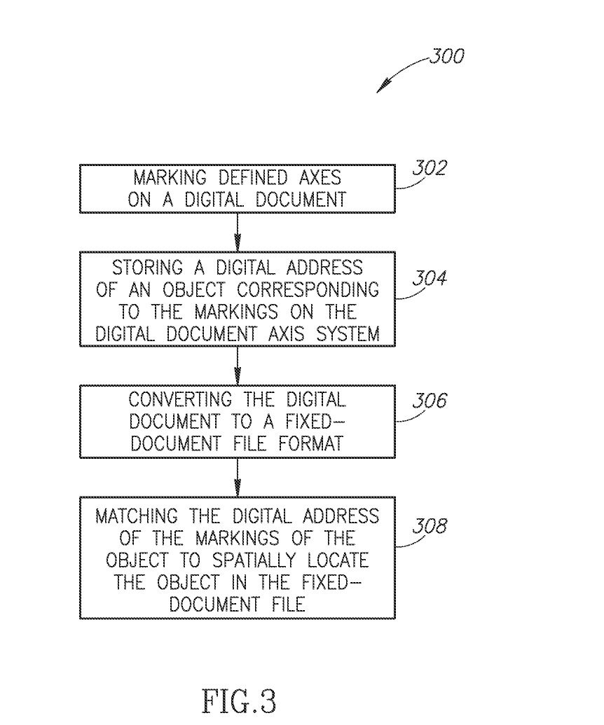

FIG. 3 is a flowchart showing a method 300 of determining an object location relative to a converted digital document according to an embodiment of the invention. At block 302 defined axes are marked within a digital document. The axes may be defined as columns and rows in a spreadsheet or may be defined by a user based on font, page size, page spacing, paragraph spacing or another grid system corresponding to the type of digital document. The axes are marked using sequential colors, fonts, patterns, art, letters, shapes or any other searchable distinctive marking The markings preferably have a height and width that can be used to define the height and width of an object.

At block 304, an object address corresponding to the digital document axis system is stored. The object address includes a unique identifier for the object. In some embodiments, the object address includes information related to markings such as thirty-two bit color information. The object address identifies the object and links the object to the markings associated with an area where the object is located on the digital document.

At block 306, the digital document is converted into a fixed-document file format such as an XPS file. As described above an XPS file represents visually a digital document as it will be printed. At block 308, the object address of the markings of the object is matched to the markings in the XPS file to locate the object spatially in the fixed-document format file. The XPS file is parsed and locations of the markings are determined. The markings related to each object address are matched to the marking location information from the XPS file. The matched markings are used to generate spatial location information for each object.

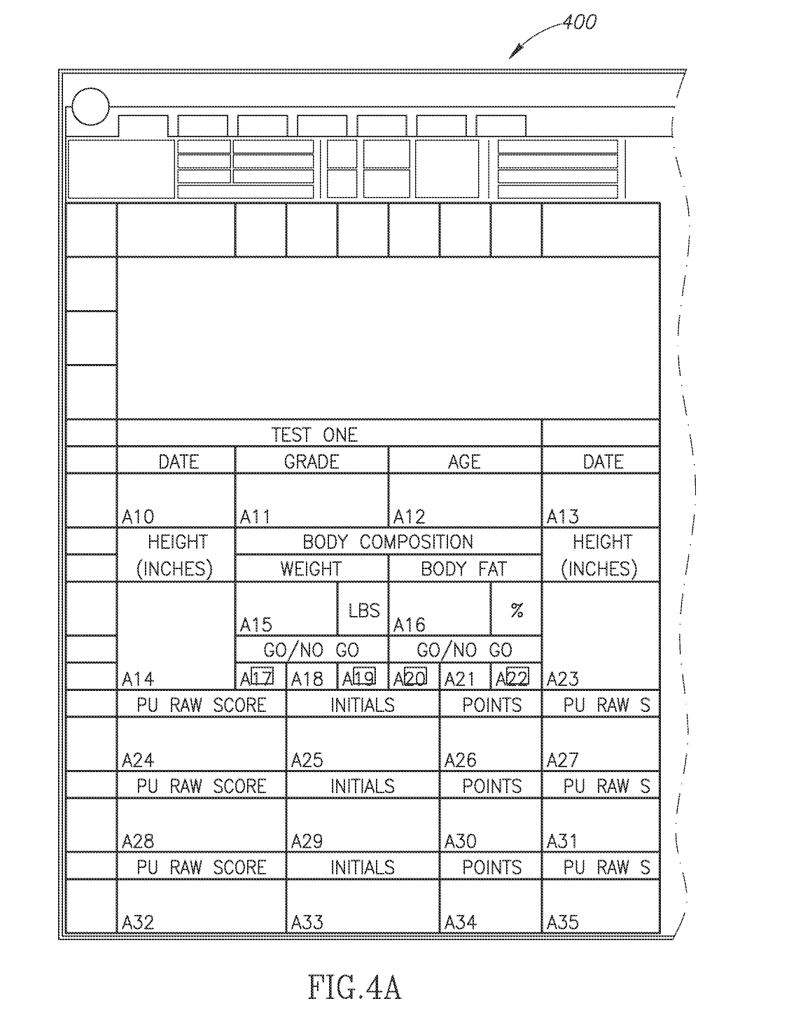

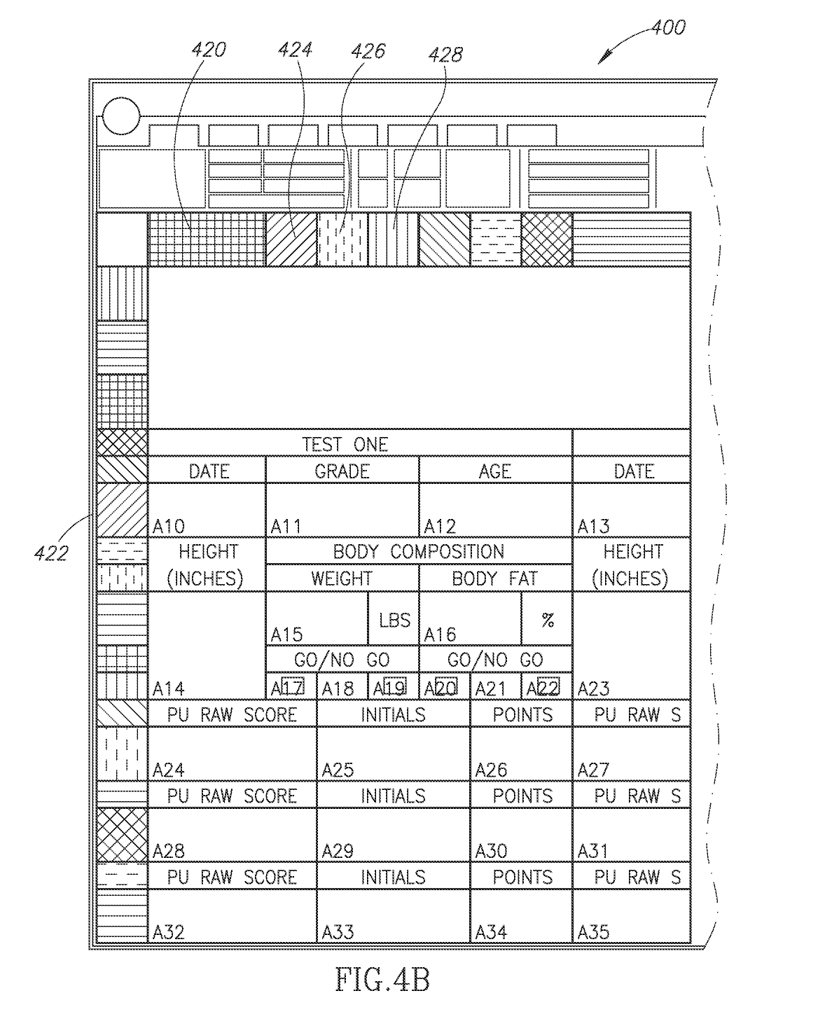

FIG. 4A shows a screen view of a digital document 400 having a variety of objects according to an embodiment of the invention. In one embodiment, the digital document 400 is in the form of a spreadsheet. The spreadsheet comprises a series of cells. Each of the cells configured for user input are objects, as defined above, and are labeled with a digital address starting with the alphanumeric character “A.”

FIG. 4B shows a screen view of a digital document 400 have the objects of FIG. 4A corresponding to a coded axis system according to an embodiment of the invention. These coded axis system includes markings in the first cell of each row and in the first cell of each column. Each object in FIG. 4B has at least one marking defining its axes. For example object A10 is defined by markings 420 and 422. Object A11 is defined by marking 422 but also markings 424, 426, and 428. Object A11 has additional markings because A11 is likely a merged cell. In alternate embodiments Object A11 may be solely defined by marking 422 and 424 defining its top left corner. In an alternate embodiment the digital address includes additional encoding to signify its related markings

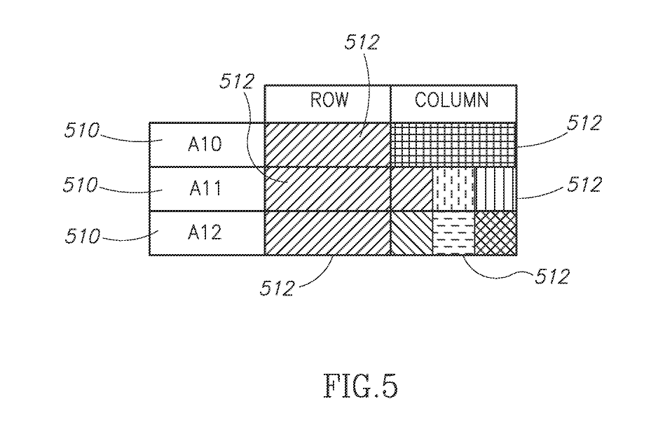

FIG. 5 shows a screen view of a table for storing a relationship between an object address and a coded axis system according to an embodiment of the invention. FIG. 5 shows a subset of objects 510 as defined in FIG. 4A and 4B. Each object 510 is stored with its related markings 512.

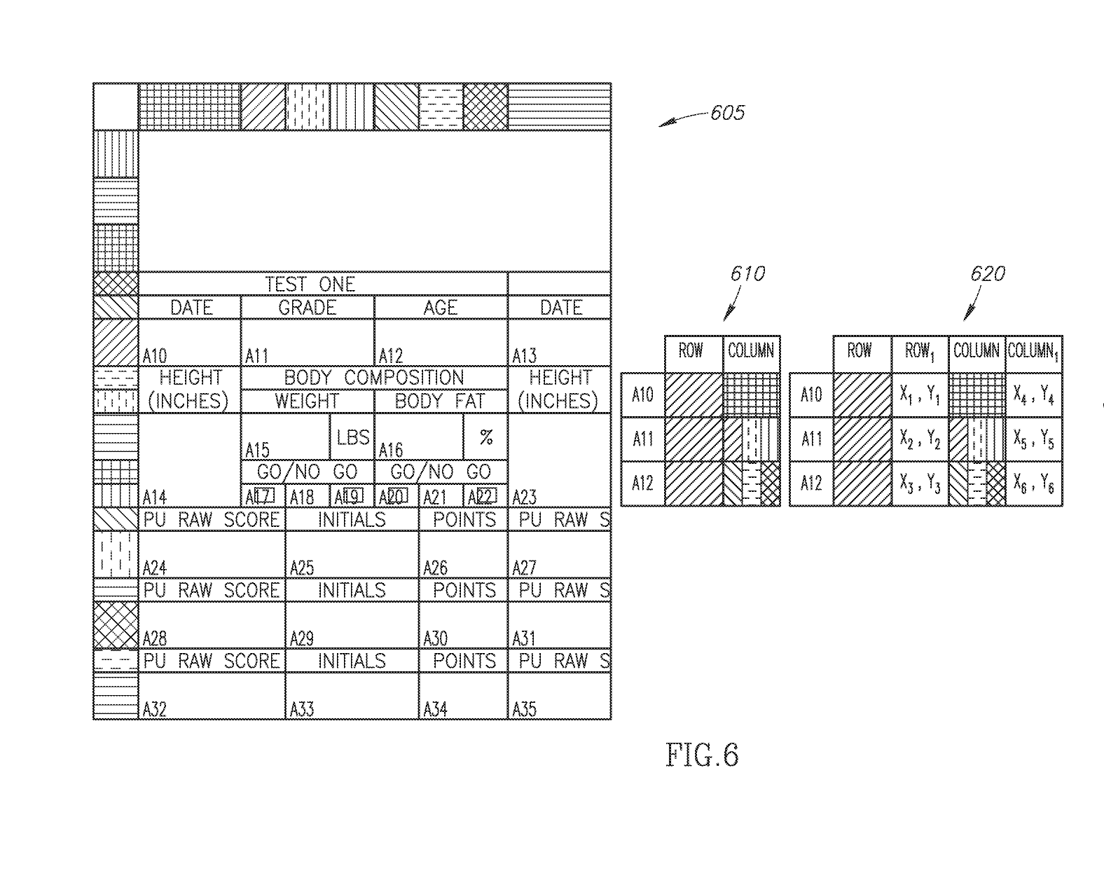

FIG. 6 shows the digital document of FIG. 4B converted according to an embodiment of the invention. When converted, the XPS document 605 has the same markings as the digital document shown in FIG. 4B. However, as explained above the XPS document 605 is a reliable description of what a document will look like when printed. The XPS document 605 is used to determine location information of an object on a printed page. In order to determine the new location of each object within the digital document, the table 610, which was created based on the digital document in FIG. 4B, is used to determine the objects digital address and related markings. The XPS document 605, is parsed to determine locations of the series of markings within the document. As shown in table 620, the location information of the markings is then matched to the markings stored with respect to each object. Once the markings are matched with the digital address of each object, the information is used to spatially locate each object on the document.

In alternative embodiments, the digital document may be exported to XPS without markings and the XPS may be parsed using visual elements in each object. In another alternate embodiment, the digital document could have a series of gridlines at a set interval and those gridlines could be counted to determine a relative position on a page. In yet another embodiment, each cell or object could be colored and each object located based on its fill color. In yet another embodiment, a combination of shapes and colors may be used to define objects. In yet another embodiment, cells can be colored that represent both column and rows, such as diagonally.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method for determining a location of text during conversion of a digital spreadsheet to a fixed file format spreadsheet, the method comprising:
recording handwritten strokes with a digital pen, the handwritten strokes received within a cell of the digital spreadsheet;
uploading data from the digital pen to generate a screen-viewable spreadsheet;
converting the handwritten strokes to typed text;
determining an address for a cell before conversion of the screen-viewable spreadsheet into the fixed file format spreadsheet, wherein the cell address identifies a column and a row of the spreadsheet digital document, and wherein the fixed file format spreadsheet is a printable version of the screen-viewable spreadsheet;
associating the cell address to both row and column markings that intersect at the cell when projected along a row and along a column of the screen-viewable spreadsheet;
converting the screen-viewable spreadsheet to the printable version of the spreadsheet;
from the printable version, re-associating the cell address with the row and column markings;
spatially locating the text on the printable version, wherein the text is positioned in the cell and the cell is located consistent with the re-associated cell address and row and column markings.

2. The method of claim 1 wherein the markings comprise colors, color shades, shapes, and line patterns.

3. The method of claim 1 wherein the fixed file format document is an XPS file format document.
